(19) United States
(12) Patent Application Publication
(10) Pub. No.: US 2021/0310573 A1
(43) Pub. Date: Oct. 7, 2021

(54) Valve for Inflatable Bladder

(71) Applicant: HO YU TEXTILE CO., LTD., Taoyuan City (TW)

(72) Inventors: Ching-Lun Jwo, Taoyuan City (TW); Ho-Chan TSAI, Taoyuan City (TW)

(73) Assignee: HO YU TEXTILE CO., LTD., Taoyuan City (TW)

(21) Appl. No.: 16/301,161

(22) PCT Filed: Jan. 16, 2018
(86) PCT No.: PCT/CN2018/072768

§ 371 Date: Nov. 13, 2018

(51) Int. Cl. F16K 15/20; F16K 15/14; F16K 15/18

(52) U.S. Cl. CPC F16K 15/205; F16K 15/202; F16K 15/185; F16K 15/148

(57) ABSTRACT

A valve for an inflatable bladder is provided with a valve seat including an annular flange and flexible supports surrounded by the annular flange; a positioning member surrounded by the flexible supports, the positioning member including a central hole; a diaphragm having a central portion secured to the central hole and an outer edge releasably secured to a bottom of the valve seat; and a cap for securing onto the valve seat.

### BACKGROUND OF THE INVENTION

### 1. Field of the Invention

The invention relates valves and more particularly to a valve capable of conveniently deflating an inflatable bladder.

### 2. Description of Related Art

Daily products are more convenient to use as the technologies advance. For deflating an inflatable bladder (e.g., inflatable swimming pool, inflatable pillow, inflatable bed, and inflatable tent), an individual has to continuously press the bladder to expel air via a check valve.

A conventional valve 80 for an inflatable bladder 81 is shown in FIG. 7 and comprises a valve seat 82, a cap 83 formed with the valve seat 82, a diaphragm 84 in the valve seat 82, a sponge member 85 below the diaphragm 84, and a plastic member 86 below the sponge member 85. For deflating the inflatable bladder 81, an individual has to use a finger to continuously press the diaphragm 84 which in turn deforms the sponge member 85 by pressing. Thus, a gap between the valve seat 82 and the diaphragm 84 is formed. As a result, air is expelled via the gap. After the pressing has been stopped, the diaphragm 84 returns to it original shape to close the gap by adhering to the valve seat 82 due to expansion of the sponge member 85. As an end, air inside the inflatable bladder 81 is prevented from exiting via the gap.

However, the deflating operation is labor intensive due to the continuous pressing of the diaphragm 84 by the finger.

Another conventional valve 90 for an inflatable bladder is shown in FIG. 8 and comprises a valve seat 91, a cap 92 formed with the valve seat 91 for disposing in the valve seat 91, and a cover 93 for closing the cap 92. Air is pumped into the bladder via the cap 92. The cover 93 is put on the cap 92 for sealing the valve 90 after inflating the bladder. For deflating the inflatable bladder, an individual has to open the cover 93 and the cap 92 sequentially. However, the operating steps are very complicated. Further, the valve 90 is relatively high, bulky and not compact. Thus, the need for improvement still exists.

### SUMMARY OF THE INVENTION

The invention has been made in an effort to solve the problems of the conventional art including complicated inflating and deflating operations and labor intensive deflating steps by providing a valve mounted on an inflatable bladder, the valve having characters including being easy to operate to deflate the inflatable bladder, simple components, portability, and wide applications.

To achieve above and other objects of the invention, the invention provides a valve, characterized by comprising a valve seat including an annular flange and a plurality of flexible supports surrounded by the annular flange; a positioning member surrounded by the flexible supports, the positioning member including a central hole; a diaphragm having a central portion secured to the central hole and an outer edge releasably secured to a bottom of the valve seat; and a cap configured to secure onto the valve seat.

Preferably, the valve seat further comprises an annular groove disposed between an inner surface thereof and the flexible supports, and a plurality of spacers each disposed between two adjacent ones of the flexible supports; and the cap includes an annular enlargement on a bottom, the enlargement being configured to insert into the annular groove of the valve seat.

Preferably, the diaphragm includes an upward extending central shaft having an end enlargement configured to secure to the central hole of the positioning member.

Preferably, the valve seat further comprises an annular trough on an underside, the trough having a diameter greater than that of the diaphragm.

Preferably, the cap is a hollow cylinder and includes a plurality of ribs on an inner surface.

Preferably, the cap further comprises an annular flange member on an outer surface of the cap, the annular flange member being away from the enlargement, and a handle extending out of the annular flange member, the handle having a plurality of slip-resistant ridges.

Preferably, the cap further comprises a link interconnected to the valve seat and the annular flange member, wherein the annular flange member of the cap is formed integrally with both the link and the valve seat.

Preferably, the cap further comprises a link interconnected to the annular flange of the valve seat and the annular flange member of the cap, wherein the annular flange member of the cap is formed integrally with both the link and the annular flange of the valve seat.

Preferably, the annular flange of the valve seat is configured to mount on an inflatable bladder.

Preferably, the flexible supports are equally spaced apart and formed integrally with the positioning member.

By utilizing the invention, pressurized air is pumped into the inflatable bladder via both the valve seat and the diaphragm. For deflating the inflatable bladder, it is required to use the finger to press the positioning member to compress the flexible supports to a minimum height. And in turn, a central portion of the valve seat is deformed and lowers. Also, portions of the diaphragm other than its central portion disengage from the valve seat due to the disengagement of the outer edge of the diaphragm from the trough of the valve seat. As a result, air begins to exit the inflatable bladder. For returning the diaphragm to its original position, it is required to use the finger to push the bottom of the diaphragm upward. And in turn, the energized flexible supports cause the diaphragm to return to its original position.

The invention has the following advantages and benefits in comparison with the conventional art:

1. In the operation of deflating the inflatable bladder, the finger may press the positioning member once to compress the flexible supports. And in turn, portions of the diaphragm other than its central portion disengage from the valve seat. As a result, air exits the inflatable bladder. A simple upward pushing of the diaphragm can return the diaphragm to its original position.

2. After opening the cap, a single step is sufficient to inflate or deflate the inflatable bladder. It is easy to operate. It is compact and portable and being easy to store due to its integral design. Thus, the invention has many applications.

The above and other objects, features and advantages of the invention will become apparent from the following detailed description taken with the accompanying drawings.

### BRIEF DESCRIPTION OF THE DRAWINGS

FIG. 1 is a perspective view of a valve for an inflatable bladder according to the invention, the valve being closed;

FIG. 2 is a perspective view of the valve being open;

FIG. 3 an exploded view of the valve of FIG. 2 in part section;

FIG. 4 is a sectional view taken along line 4-4 of FIG. 1;

FIG. 5 is a view similar to FIG. 4 with the valve being open for inflating the bladder with air;

FIG. 6 is a view similar to FIG. 5 with a finger being going to press the diaphragm for deflating the bladder;

FIG. 7 is a perspective view of a conventional valve for an inflatable bladder, the valve being open and the finger being going to press the diaphragm for deflating the bladder; and

FIG. 8 is a perspective view of another conventional valve for an inflatable bladder, the valve being open.

### DETAILED DESCRIPTION OF THE INVENTION

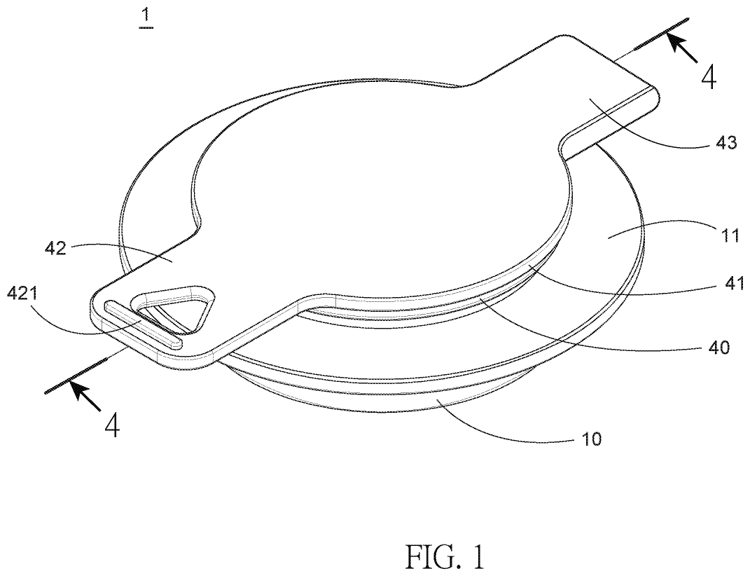

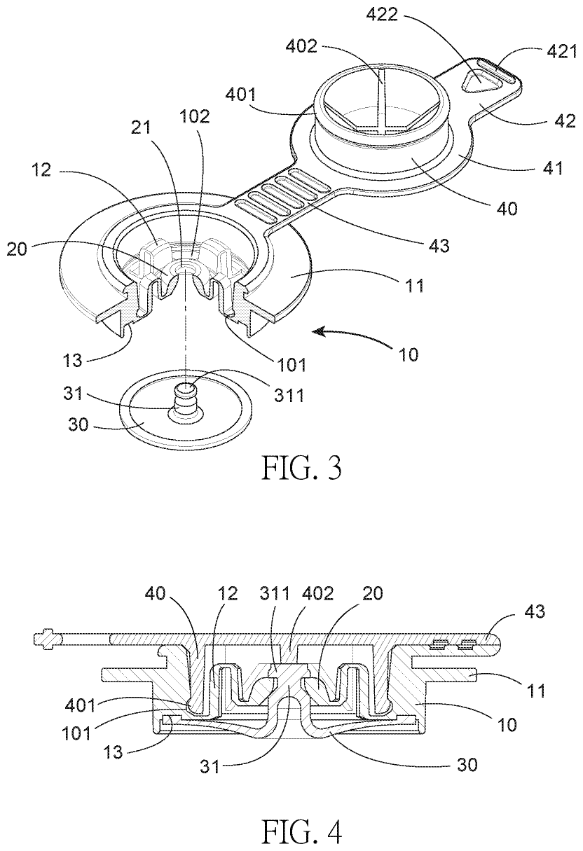

Referring to FIGS. 1 to 6, a valve 1 for an inflatable bladder 50 in accordance with a preferred embodiment of the invention is shown. It is noted that the invention is not limited by the described preferred embodiment.

The valve 1 of the invention is mounted on the inflatable bladder 50 and comprises a short, hollow, cylindrical valve seat 10 including an annular flange 11 on a top, the flange 11 being secured to the bladder 50, four equally spaced flexible supports 12 surrounded by an inner surface of the valve seat 10, an annular groove 101 between the flexible supports 12 and an inner surface of the valve seat 10, and a plurality of spacers 102 each disposed between two adjacent flexible supports 12.

There is further provided a positioning member 20 integral with the flexible supports 12. The positioning member 20 is at a center of the flexible supports 12. The flexible supports 12 are equally spaced apart. The positioning member 20 includes a central hole 21.

There is further provided a diaphragm 30 made of silicon gel. The diaphragm 30 includes a central shaft 31 extending upward, the shaft 31 having an enlargement 311 at an end. The enlargement 311 is fastened on the central hole 21. The outer edge of the diaphragm 30 is releasably secured to a bottom of the valve seat 10

There is further provided a short, hollow, cylindrical cap 40 adapted to secure onto the valve seat 10. The cap 40 includes an annular enlargement 401 on a bottom. The enlargement 401 is adapted to insert into the groove 101 to fasten the cap 40 and the valve seat 10 together.

As shown in FIGS. 1 to 4 specifically, the valve seat 10 further comprises an annular trough 13 on an underside. The trough 13 has a diameter greater than that of the diaphragm 30. The raised edge of the diaphragm 30 is inserted into the trough 13. Thus, the diaphragm 30 is fastened. Purpose of the spacers 102 is to prevent the diaphragm 30 from pushed further toward the valve seat 10.

Four equally spaced ribs 402 are formed on an inner surface of the cap 40. The ribs 402 can increase the structural strength of the cap 40 so that the cap 40 may not be subject to deformation.

An annular flange 41 is formed on an outer surface of the cap 40 and spaced from the ribs 402. A handle 42 is extended out of the flange 41. The handle 42 has a plurality of slip-resistant ridges 421 and an opening 422 for allowing the hand to get a better grip of the handle 42.

A link 43 is formed to interconnect to the valve seat 10 and the flange 41. The flange 41, the link 43 and the valve seat 10 are formed integrally.

In another preferred embodiment of the invention, the link 43 interconnects to the flange 11 and the flange 41. The flange 41, the link 43 and the flange 11 are formed integrally.

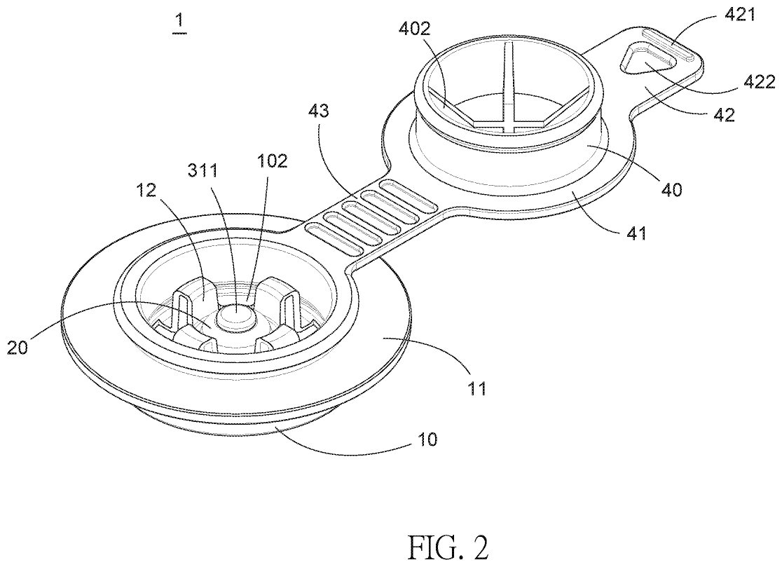

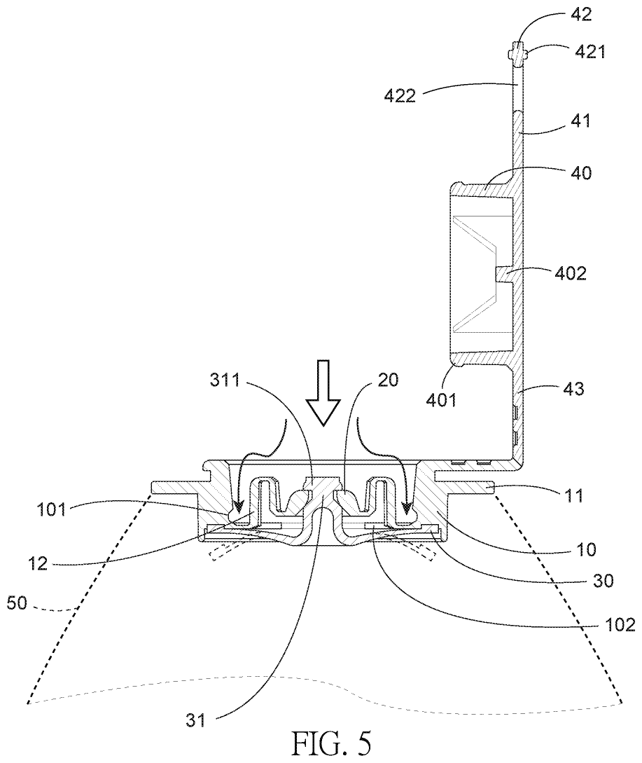

As shown in FIGS. 2 and 5 specifically, for inflating the inflatable bladder 50, it is required to place an adapter of an air pump (or air compressor) onto the spacers 102 of the valve seat 10. Next, the air pump (or the air compressor) is activated to pump air into the inflatable bladder 50 via the diaphragm 30. The inflating step is stopped when the inflatable bladder 50 is fully filled with air.

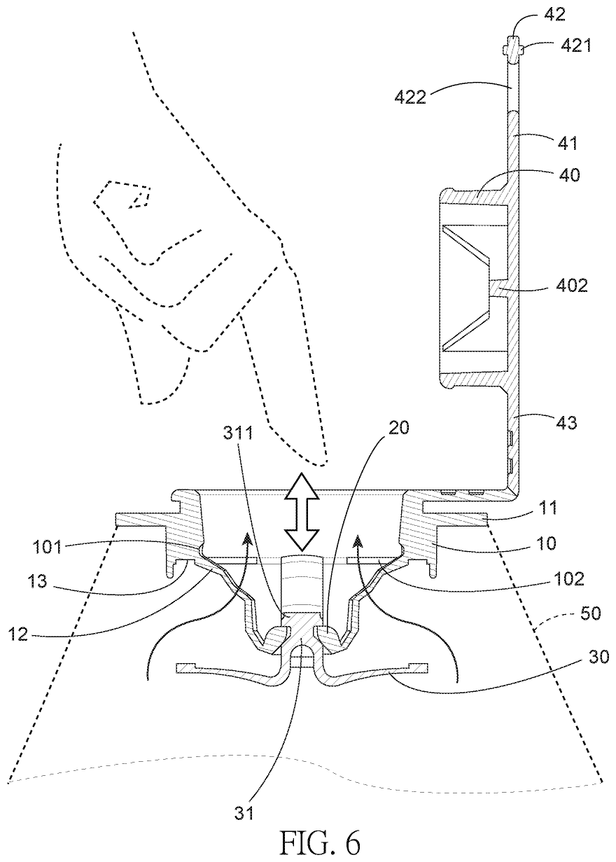

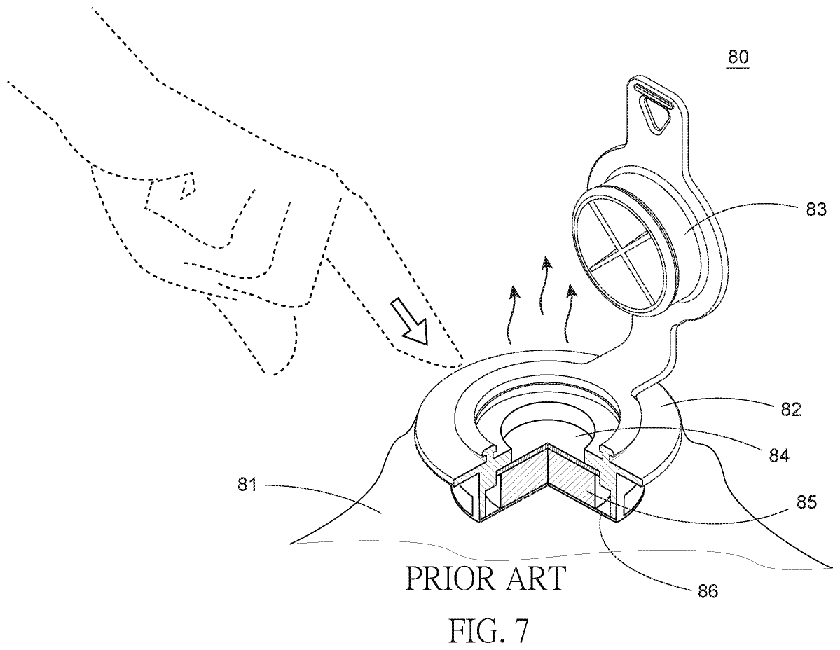

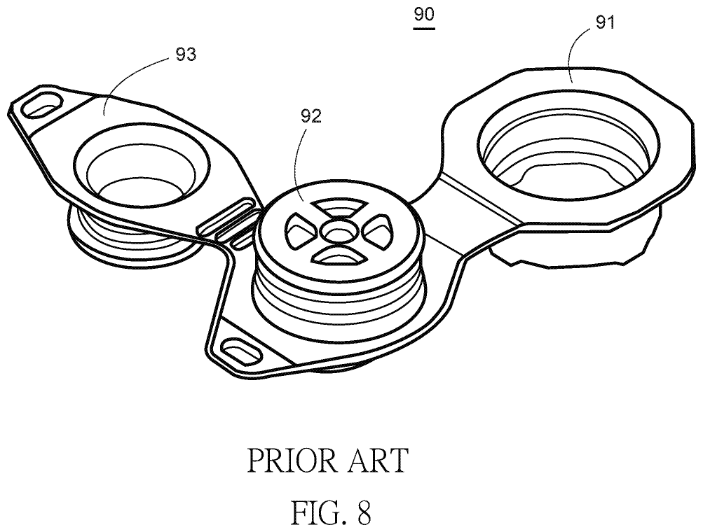

As shown in FIG. 6 specifically, for deflating the inflatable bladder 50, it is required to use the finger to press the positioning member 20 once to compress the flexible supports 12 to a minimum height. And in turn, a central portion of the valve seat 10 is deformed and lowers. Also, portions of the diaphragm 30 other than its central portion disengage from the valve seat 10 due to the disengagement of the raised edge of the diaphragm 30 from the trough 13 of the valve seat 10. As a result, air begins to exit the inflatable bladder 50.

For returning the diaphragm 30 to its original position, it is required to use the finger to push the bottom of the diaphragm 30 upward. And in turn, the resilient force of the energized flexible supports 12 causes the diaphragm 30 to return to its original position. As a result, the raised edge of the diaphragm 30 is inserted into the trough 13 again.

It is envisaged by the invention that the valve 1 is adapted to mount on the inflatable bladder 50 such as inflatable pillow, inflatable bed, inflatable tent or the like.

While the invention has been described in terms of preferred embodiments, those skilled in the art will recognize that the invention can be practiced with modifications within the spirit and scope of the appended claims.

What is claimed is:

1. A valve, characterized by comprising:
a valve seat including an annular flange and a plurality of flexible supports surrounded by the annular flange;
a positioning member surrounded by the flexible supports, the positioning member including a central hole;
a diaphragm having a central portion secured to the central hole and an outer edge releasably secured to a bottom of the valve seat; and
a cap configured to secure onto the valve seat.

2. The valve of claim 1, characterized in that the valve seat further comprises an annular groove disposed between an inner surface thereof and the flexible supports, and a plurality of spacers each disposed between two adjacent ones of the flexible supports; and the cap includes an annular enlargement on a bottom, the enlargement being configured to insert into the annular groove of the valve seat.

3. The valve of claim 1, characterized in that the diaphragm includes an upward extending central shaft having an end enlargement configured to secure to the central hole of the positioning member.

4. The valve of claim 1, characterized in that the valve seat further comprises an annular trough on an underside, the trough having a diameter greater than that of the diaphragm.

5. The valve of claim 1, characterized in that the cap is a hollow cylinder and includes a plurality of ribs on an inner surface.

6. The valve of claim 2, characterized in that the cap further comprises an annular flange member on an outer surface of the cap, the annular flange member being away from the enlargement, and a handle extending out of the annular flange member, the handle having a plurality of slip-resistant ridges.

7. The valve of claim 6, characterized in that the cap further comprises a link interconnected to the valve seat and the annular flange member, wherein the annular flange member of the cap is formed integrally with both the link and the valve seat.

8. The valve of claim 7, characterized in that the cap further comprises the link interconnected to the annular flange of the valve seat and the annular flange member of the cap, wherein the annular flange member of the cap is formed integrally with both the link and the annular flange of the valve seat.

9. The valve of claim 1, characterized in that the annular flange of the valve seat is configured to mount on an inflatable bladder.

10. The valve of claim 1, characterized in that the flexible supports are equally spaced apart and formed integrally with the positioning member.
